(19) United States
(12) Patent Application Publication
(10) Pub. No.: US 2021/0326743 A1
(43) Pub. Date: Oct. 21, 2021

(54) DEEP CELLULAR RECURRENT NEURAL NETWORK HAVING ARCHITECTURE AND METHOD FOR EFFICIENT ANALYSIS OF TIME-SERIES DATA HAVING SPATIAL INFORMATION

(71) Applicant: Old Dominion University, Norfolk, VA (US)

(72) Inventors: Khan M. Iftekharuddin, Virginia Beach, VA (US); Lasitha S. Vidyaratne, Norfolk, VA (US); Alexander Glandon, Norfolk, VA (US); Mahbubul Alam, Norfolk, VA (US)

(73) Assignee: Old Dominion University, Norfolk, VA (US)

(21) Appl. No.: 16/850,921

(22) Filed: Apr. 16, 2020

(51) Int. Cl. G06N 20/00; G06N 3/04; G06F 17/16

(52) U.S. Cl. CPC G06N 20/00; G06F 17/16; G06N 3/0454

(57) ABSTRACT

A machine learning system and method configured to receive information from a plurality of sensors being located on a computational front-end; a deep cellular recurrent neural network configured to receive time-series data input from each of the plurality of sensor; and one or more feed-forward layers being located on a computational back-end configured to receive data output, the data output being processed by the deep cellular recurrent neural network. The deep cellular recurrent neural network further includes a plurality cellular long short-term memory networks arranged in corresponding nodes, wherein each of the plurality of cellular long short-term memory networks are interconnected to at least one adjacent cellular long short-term memory module.

### COPYRIGHT STATEMENT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

### 1. Field of the Invention

The disclosure relates to systems and methods of machine learning and particularly to the use of Deep Recurrent Neural Networks (DRNN) in conjunction with Long Short-Term Memory (LSTM).

### 2. Description of the Prior Art

Efficient processing of large-scale time-series data is an intricate problem in machine learning. Conventional sensor signal processing pipelines with hand engineered feature extraction often involve huge computational cost with high amounts of dimensional data and initial training to train the systems to recognize particular patterns early on. However, as generic deep recurrent models grow in scale and depth with increased complexity of the data, it becomes particularly challenging in presence of high dimensional data having both temporal and spatial information. Further, the amount of tailored initial training typically has caused these systems to be extremely narrow in their implementable scope where systems developed based on a particular parameter set are then incapable of being used with additional inputs or in diverse data applications.

### BRIEF DESCRIPTION OF THE INVENTION

Consequently, this invention proposes a novel deep cellular recurrent neural network (DCRNN) architecture which can be used to efficiently process complex multi-dimensional time-series data with spatial information, allow for a common processing platform with multiple input sources, and reduce the computation burden on a particular input node by allowing synchronized data processing by a plurality of LSTM nodes or modules provided in an interconnected array or matrix.

The cellular recurrent architecture in the proposed model allows for location-aware synchronous processing of time-series data from spatially distributed sensor signal sources.

Extensive trainable parameter sharing due to cellularity in the proposed architecture ensures efficiency in the use of recurrent processing units with high-dimensional inputs. This architecture as contained in this disclosure also allows for applicability of the proposed DCRNN model for classification of multi-class time-series data from completely different domains with similar inherent spatial organization.

As such, contemplated herein is a machine learning system can include a plurality of sensors being located on a computational front-end; a deep cellular recurrent neural network configured to receive time-series data input from each of the plurality of sensor, and one or more feed-forward layers which can be located on a computational back-end configured to receive data output, the data output being processed by the deep cellular recurrent neural network. In such embodiments, the deep cellular recurrent neural network which can include: a plurality cellular long short-term memory networks arranged in corresponding nodes, wherein each of the plurality of cellular long short-term memory networks are interconnected to at least one adjacent cellular long short-term memory module.

In some embodiments, the plurality of sensors can be arranged in a nodular array, wherein the plurality of sensors can then be configured to provide the time-series data input in a nodular array corresponding in parameters to the nodular array in which the plurality of sensors are arranged.

In some embodiments, the plurality cellular long short-term memory networks are arranged in a nodular array corresponding in shape to the nodular array in which the time-series data input is arranged.

In some embodiments, the nodular array of the time-series data input can be provided in the form of a matrix having a plurality of columns and rows each cell in the matrix being representative of the time-series data input being provided by each of the plurality of sensors.

In some embodiments, the matrix representative of the nodular array of the time-series data input can be provided being symmetrical about one or more axes of the matrix. In some such embodiments, the matrix representative of the nodular array of the time-series data input can be provided being symmetrical about both horizontal and vertical axes of the matrix.

In some embodiments, each of the plurality cellular long short-term memory networks can be provided with one or more unique communication channels between one or more adjacent cellular long short-term memory networks.

In some embodiments, each of the plurality cellular long short-term memory networks can be configured to share computational load between adjacent long short-term memory network nodes through the unique communication channel.

In some embodiments, a plurality of adjacent long short-term memory network nodes can be configured to receive and to analyze data from a common cell of the matrix representing the nodular array of the time-series data input.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates an organizational schematic of an exemplary deep cellular recurrent neural network having architecture capable of efficient analysis of time-series data having spatial information being illustrative of various aspects of the present invention;

FIG. 2 illustrates a schematic of an exemplary implementation of the exemplary deep cellular recurrent neural network having architecture capable of efficient analysis of time-series data having spatial information of FIG. 1 as applied to a plurality of EEG as laid out onto a patient's head this exemplary application being illustrative of various aspects of the present invention;

FIG. 3 illustrates a schematic of an exemplary implementation of the exemplary deep cellular recurrent neural network having architecture capable of efficient analysis of time-series data having spatial information of FIG. 1 as applied to an array of a plurality of fault sensors as applied to a cryomodule of a continuous electron beam accelerator this exemplary application being illustrative of various aspects of the present invention;

FIG. 4 illustrates a conceptual schematic of a synchronized long short-term memory array adaptable for use in the deep cellular recurrent neural network having architecture capable of efficient analysis of time-series data having spatial information of FIG. 1;

FIG. 5 illustrates a conceptual schematic of a particular cell or node of the long short-term memory array adaptable for use in the deep cellular recurrent neural network having architecture capable of efficient analysis of time-series data having spatial information of FIG. 1;

FIG. 6 illustrates an exemplary algorithm for use in conjunction with the exemplary deep cellular recurrent neural network having architecture capable of efficient analysis of time-series data having spatial information of FIG. 1;

FIG. 7 illustrates a graphical representation which summarizes the patient specific EEG classification results obtained with the exemplary deep cellular recurrent neural network having architecture capable of efficient analysis of time-series data having spatial information of FIG. 1;

FIG. 8 illustrates a table which compares the seizure detection performance of the exemplary deep cellular recurrent neural network having architecture capable of efficient analysis of time-series data having spatial information of FIG. 1 with other studies in the prior art;

FIG. 9 illustrates another table showing a 10-fold cross validation performance of the exemplary deep cellular recurrent neural network having architecture capable of efficient analysis of time-series data having spatial information of FIG. 1 as compared with other methods;

FIG. 10 illustrates n example waveform extracted from a cavity from the implementation as shown in FIG. 3; and

FIG. 11 illustrates a ROC curve of the exemplary deep cellular recurrent neural network having architecture capable of efficient analysis of time-series data having spatial information of FIG. 1 utilizing the implementation as shown in FIG. 3.

Reference will now be made to the exemplary embodiments illustrated, and specific language will be used herein to describe the same. It will nevertheless be understood that no limitation of the scope of the invention is thereby intended.

### DETAILED DESCRIPTION

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Contemplated herein is a deep cellular recurrent neural network (DCRNN) capable of performing efficient analysis of time-series data with spatial information, which includes a network of embedded long short-term memory modules which can then be configured so as to analyze a plurality of data inputs from a plurality of independent systems or sensors.

It has been recognized that efficient processing of large-scale time-series data is an intricate problem in machine learning. In previous systems implementing conventional sensor signal processing pipelines required extensive tailored feature extraction which typically required huge computational cost with high dimensional data and extensive initial training based on human supervised scenarios.

It has been recognized that deep recurrent neural networks have shown promise in automated feature learning for improved time-series processing. However, generic deep recurrent models do not scale well with associated increases in depth and increased complexity of the data. This is particularly challenging in presence of high dimensional data with temporal and spatial characteristics.

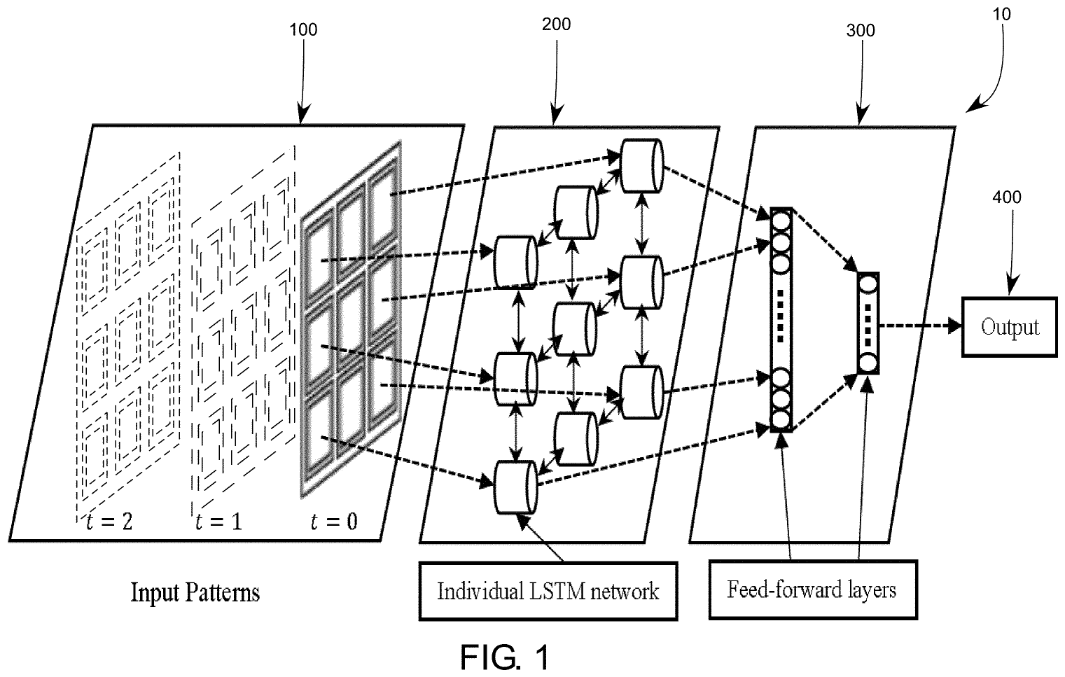

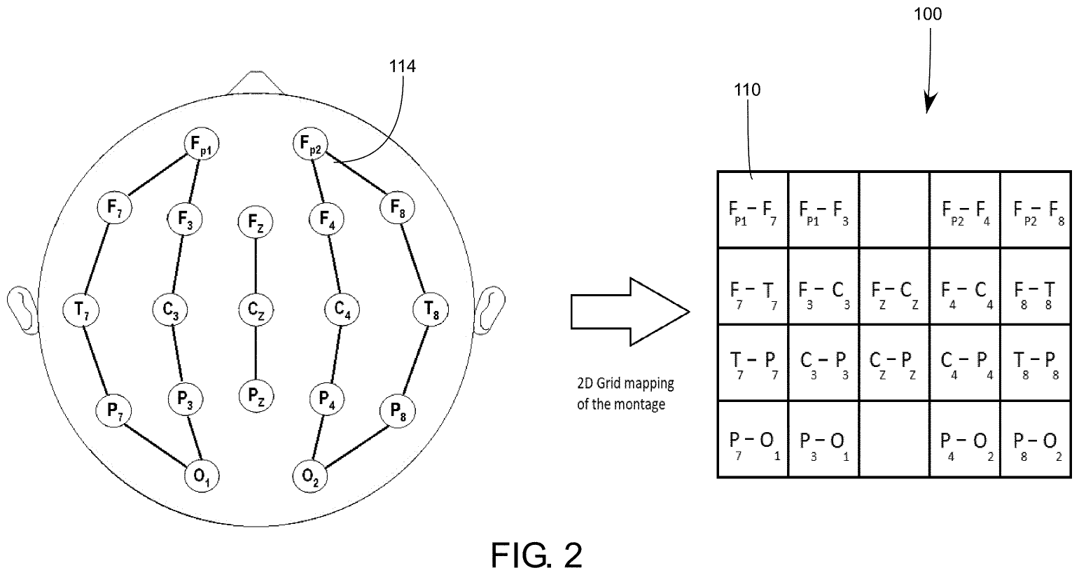

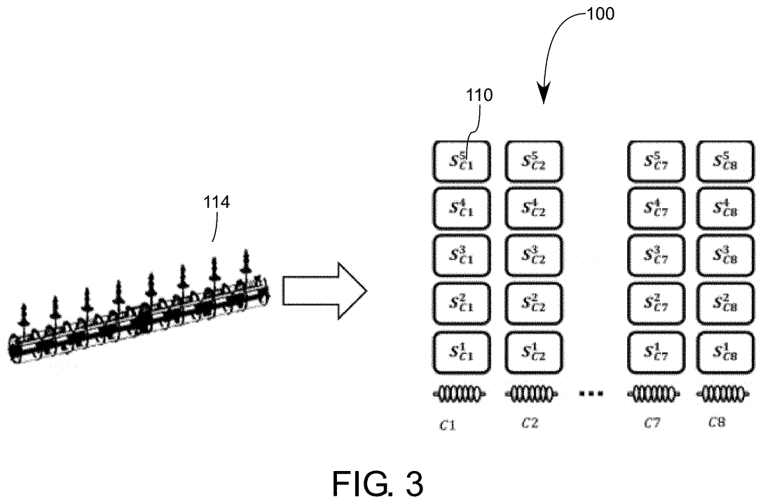

Consequently, and as shown in FIGS. 1-5, this disclosure illustrates a novel deep cellular recurrent neural network (DCRNN) architecture 10 which can efficiently process complex multi-dimensional time-series data with spatial information. The cellular recurrent architecture as contemplated herein allows for location-aware synchronous processing of time-series data from spatially distributed sensor signal sources. Extensive trainable parameter sharing is enabled due to cellularity in the proposed architecture which ensures efficiency in the use of recurrent processing units with high-dimensional inputs. The proposed DCRNN architecture will be illustrated utilizing two exemplary time-series datasets: a multichannel scalp EEG dataset for seizure detection as shown in FIG. 2, and a machine fault detection dataset as illustrated in FIG. 3, with the understanding that these exemplary implementations are made only by way of illustration and could be similarly applied to any particular sensor either individually or in an array. By utilizing the proposed architecture, it is possible to achieve substantial increases in system performance while utilizing substantially less trainable parameters when compared to pre-existing comparable methods.

Typical pattern recognition applications oftentimes involve classification or regression of input data that is static in time. However, most real-world data obtained through a set of observations almost always exhibit changes with time. Though in some cases, the change of observations in time can be ignored, certain applications that particularly deal with changes across time requires an additional temporal dimension to be incorporated in the pattern recognition process.

Moreover, tasks such as monitoring multi-channel EEG for seizure detection and complex machine health monitoring may require recognition of patterns that extend in both spatial and temporal dimensions. Computational models that are specifically capable of capturing complex patterns in time and space are required to process such multi-dimensional time-series data. One of the most challenging steps in constructing a machine learning model for complex time-series analysis is an appropriate feature extraction scheme that effectively captures the patterns across time and spatial dimensions.

These representative features can be expressed as a set of simple statistics of the time-series data such as mean, variance, skewness, kurtosis, largest peak, and number of zero crossings. More descriptive features such as autoregressive coefficients, frequency power spectral features, and features derived from time-frequency analysis. Some such time-frequency analysis features can include: wavelet transform, wavelet packet transform, filter banks, and self-similarity features. Additionally, further engineered versions of these may also be considered to obtain a more discriminatory representation of data.

However, one of the main problems associated with feature engineering is that the efficacy of such features essentially depend on the data, and the application. Therefore, the performance of a machine learning pipeline depends on the hand selection of a subset of features, or extraction of a set of new features based on the domain expertise. Feature learning with artificial neural networks (ANN) largely alleviates this problem by progressively learning the best possible discriminatory feature from data.

The availability of powerful computational tools and training methods have enabled deep neural networks to solve many difficult recognition problems in robotics, for example, object recognition, text recognition, etc.

One major limitation experienced by such systems is realized in the fact that typical feed-forward neural networks are predominantly used in processing data that is static in time due to its inability to process temporal relations owing to the limited forward information processing capability. It will then be understood that recurrent neural network (RNN), or a time-delay neural network (TDNN), which is a variant of ANN with the added capability of information aggregation through feed-back connections, wherein existing RNNs process time-series by reading samples sequentially in time, and the feed-back connections aid in retaining valuable information through time-steps.

Further improvements to the feed-back units in retaining memory through longer time-sequences are tasked to Long Short-term Memory (LSTM) units, and Gated Recurrent Units (GRU). Large-scale deep versions of recurrent neural networks have been successfully utilized in systems having multiple domains. However, none have been implemented which use deep CNN and/or deep LSTM networks for processing time-series data having spatial information such as illustrated in the EEG of FIG. 2 or the machine fault scenario of FIG. 3. Previous systems would typically require an additional feature extraction step such as Fourier spectrum computation prior to the application of CNN for improved compatibility. The deep CNN is primarily used as a feature extractor while a LSTM layer is applied subsequently for temporal processing.

Due to this existing architecture, the current state-of-the-art deep models suffer from a major limitation, namely, that the depth, complexity, and the number of trainable parameters associated to these models grow proportionally to the complexity of the input dimensionality and the given task. This proportional growth is due to the fact that the input dimensionality directly translates into the number of neurons in the first (input) layer of a feed-forward ANN and the number of tunable parameters associated with the layer. Additionally, the depth of a neural network translates to the flexibility of the architecture to approximate more complex functions. Therefore, increased complexity of input data typically require deeper neural networks. This problem is further exacerbated in recurrent learning models as the additional feed-back links demands even more trainable parameters. These additional feed-back links are necessitated because the recurrent neural networks differ from the feed-forward counterparts by having additional feed-back loops with tunable parameters between layers. Therefore, any increment of layer size and depth (due to increased input dimensionality and complexity of data as before) will increase the number of tunable parameters by at least two folds with respect to a feed-forward neural network. Therefore, such architectures can grow prohibitively in the presence of large-scale, multi-source time-series data such as those discussed herein.

Furthermore, the deep CNN and LSTM methods still largely ignore the spatial relevance in large scale time-series data for most applications where space location information is of interest, such as discussed herein with regard to the exemplary scenarios of the EEG and machine fault detection. The time-series data recorded from different components in a machine health diagnosis, and fault detection system include spatial correlation based on the locality of the components. Specifically, as discussed herein, the machine fault detection was implemented on a particle accelerator facility which contained multiple cavities situated serially on associated cryomodules. In this implementation, multiple RF signals were recorded from each cavity can then be monitoring and provide an indication with regard to one or more operating conditions. Automated detection and classification of faults in this system involves efficient processing of time-series data obtained from each cavity.

In an addition exemplary implementation, for example with EEG signal processing, when utilizing conventional CNN and LSTM architectures, these systems face similar challenges. For example, in one proposed solution an image-based representation is generated combining Fourier spectral features from individual EEG electrodes into a single image based on the 2D projection of the EEG montage. This representation maintains the spatial locality of individual EEG electrodes to exploit the spatial relevance of seizure EEG. However, this is still processed using a large-scale multi-layer CNN and LSTM combined architecture that suffer from large computational cost for the networks. The inefficiency of such architecture can be explained as follows: 1) this architecture performs a hand-crafted feature representation step (Fourier spectral feature extraction). This counters the purpose of using deep learning, which is designed to replace hand-crafting by feature learning for better performance. This step appears to be used purely for the purpose of input interfacing with a generic CNN architecture. 2) The architecture performs spatial information learning and temporal information learning in a two-step process, using two different architectures (CNN for spatial information processing, and LSTM for temporal-information processing). This results in an unnecessarily complex architecture plagued by the limitations discussed above. The proposed DCRNN architecture learns spatio-temporal features in a single step, while avoiding the limitations of the generic architectures.

Consequently, in order to address the general lack of computationally efficient methods for processing time-series data that also maintain spatial relevance, contemplated herein is a novel deep learning architecture 10 having deep cellular recurrent neural network (DCRNN) with embedded LSTM nodes within the DCRNN.

FIG. 1. illustrates a novel deep cellular recurrent neural network (DCRNN) architecture 10 which implements a cellular neural network architecture 200. Or in other words a deep cellular recurrent neural network 200 which can then be configured to receive time-series data input 100 from each of the plurality of sensors 114 being organized in to a sensor data array, wherein the deep cellular recurrent neural network 200 is provided with a plurality cellular long short-term memory networks 210 arranged in corresponding nodes within the DCRNN.

As illustrated here, the cellular neural network can include a plurality of cells, illustrated here having 9 cells in a 3×3 2D grid arrangement or a matrix. It will be appreciated that the cellular neural network can be arranged in an array having any number of rows or columns, such as the 16 cell 4×4 arrangement as illustrated in FIG. 2, or even a 4×5 20 cell or node arrangement of FIG. 3. In a preferred implementation these matrices can be provided being symmetrical about a vertical or horizontal axis in the two-dimensional plane, however, this symmetry is not mandatory for implementation. Each node of the cellular network is provided with an independent associated LSTM network 210

The typical cellular architecture spans the area of a 2D input such as an image, overlapping each pixel with a corresponding cell or node in the network. Each cell in the network of LSTM nodes is provided with a dedicated communication pathway of one or more unique communication channels 214 between neighboring nodes which can transmit and synchronize data and thus utilize neighboring nodes to process, particularly in the event of large data input streams. These communication channels are implemented by introducing neural pathways (with tunable parameters) between a dedicated output node of a candidate cell and a dedicated input node of each neighboring cell, called cellular pathways. This additional pathways are specifically implemented to carry information between each cell at each time-step governed by the input data. In essence, these pathways are synchronized with the input time-steps to share intermediate information (information pertaining to a specific time-step within the time-series input) that are produced by a specific node of cellular LSTM with its neighboring cellular LSTMs. For Example, suppose the architecture is processing a time-series data sample (with time steps t=0, 1, 2, . . . , T) at time step t. The cellular pathways share the information at the output of LSTM in each cell with its neighbors, so that the information is made available by the time the network proceeds to process time step t+1. In this manner, cellular architectures enable distributed processing of information while maintaining synchronized communication with the neighboring cells.

In some embodiments, the cellular architecture can be implemented in a manner which promotes extensive sharing of tunable parameters, this is achieved by placing identical neural structures in each cell or node of the matrix having an associated LSTM network 210. This unique cellular sub-architecture allows the DCRNN architecture to better handle multi-dimensional time-series data processing. The cellularity of the proposed architecture allows for processing sensor signals obtained from individual sources. Whereas the grid-like placement of cells in-turn enables communication with the neighboring cells, which allows learning spatial characteristics based on the locality of sensor signal sources. Extensive trainable weight sharing can also be gained by by placing identical recurrent neural models within each cell.

Moreover, the cellularity enables straightforward expansion of architecture for changes in the number of input sources, with only negligible increments to the number of trainable weights. This can be achieved through the following functionalities: 1) sharing of network architecture, and tunable parameters among cells. Due to the symmetry of input data at each location of 2D grid (data at each cell are of similar characteristics and dimensionality), we can use the same architecture to process each signal, and share the tunable parameters among cells. 2) An increment of input signal dimensionality can be directly complemented by increasing the number of cells in the network. We then use properties of 1) to minimize the resulting expansion of architecture and tunable parameters. A detailed computational complexity analysis and a comparison with a generic architecture to show this effect can be found in section III B of the paper. It is also shown in [0064] of this document.

The cellular neural network as contemplated herein is an architecture that consists of multiple cells with elements arranged in a geometric pattern or matrix, each cell or node, as discussed above, containing an associated LSTM network 210. Each element in the cellular neural network can also house a single neuron or a complex ANN. However, these elements are usually made with identical sub-structure across all nodes so as to maximize the shareability of trainable weights among the cells. A typical cellular network architecture spanning a 2D space is shown in FIGS. 1-4.

The architecture shown in these FIGs can be used to process an input that consists of sensor signal sources in a 2D spatial. In this arrangement, each cell can then be utilized to process the individual inputs of the corresponding sensor signal source. Additionally, as shown in FIG. 1, each cell in the cellular architecture includes one or more unique communication channels 214 provided between each of the neighboring cells or nodes within the matrix. These channels can, for example, allow for processing the local geometric patterns exhibited among sensor signal sources within multi-dimensional time-series data.

The generic recurrent neural networks are known to suffer from limited reach of context over time-series data in generating the network output. This is due to the limited or decaying backpropagation error over long time periods of a given time-series. This can be considered as a vanishing gradient problem over time, similar to the vanishing gradient problem that occurs over depth of a deep network architecture. Consequently, the long short-term memory networks can be implemented in a manner so as to address this vanishing error signal. In particular, the LSTM networks at each node can be provided with memory gates that control the flow of context over time.

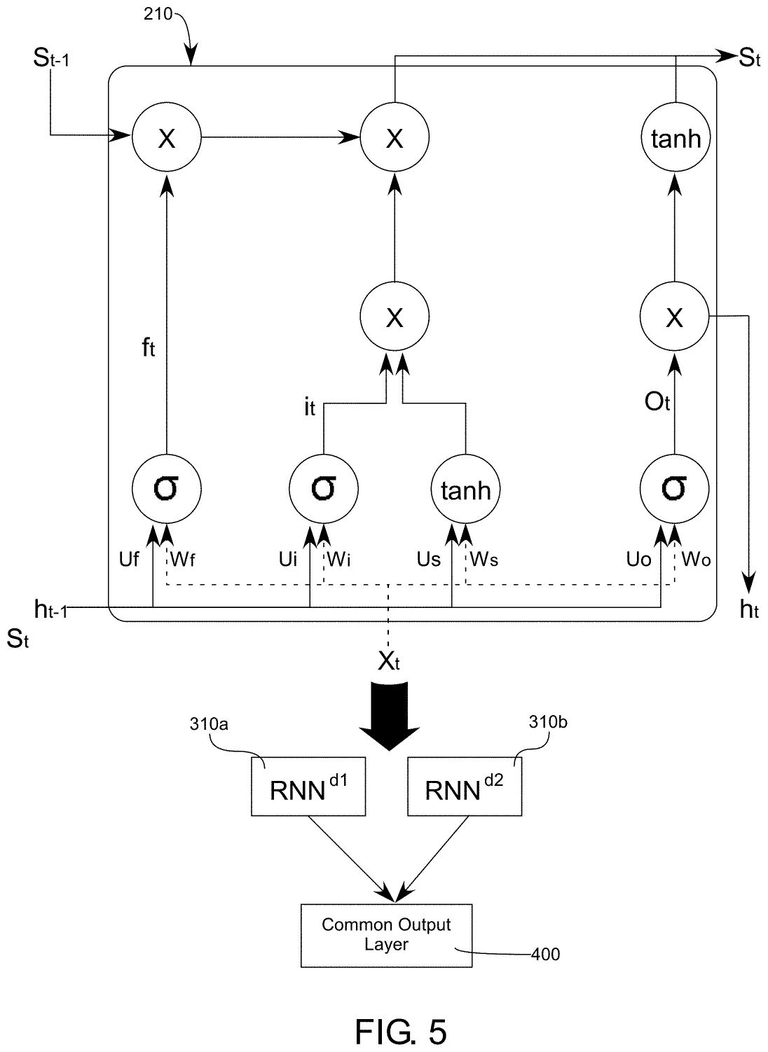

FIG. 5 in particular shows a signal flow diagram of an LSTM unit.

As discussed briefly above, the generic recurrent neural networks are known to suffer from limited reach of context over time series data in generating the network output. This is due to the limited or decaying backpropagation error over long time periods of a given time series. This can be considered as a vanishing gradient problem over time, similar to the vanishing gradient problem that occurs over depth of a deep network architecture. Consequently, the long short-term memory as contemplated here is developed to address this vanishing error signal, with the introduction of memory gates that control the flow of context over time. FIG. 5 shows a signal flow diagram of an LSTM unit, where the following equations (1)-(5) illustrate the full operation of an LSTM unit for a single time step:

iₜ=σ(Wᵢxₜ+Uᵢhₜ₋₁), (1)

fₜ=σ(Wₜxₜ+Uₜhₜ₋₁), (2)

oₜ=σ(Wₒxₜ+Uₒhₜ₋₁), (3)

sₜ=fₜ⊙sₜ₋₁+iₜ tanh(Wₛxₜ+Uₛhₜ₋₁), (4)

hₜ=oₜ⊙tanh(sₜ); (5)

Typical inputs for an LSTM at time step t includes the signal input xₜ, hidden output of the previous time step hₜ₋₁, and memory accumulated at the previous time step sₜ₋₁. The input signal xₜ and previous hidden signal hₜ₋₁ are combined in Eqns. (1)-(3) and passed through a sigmoid activation function to obtain iₜ and oₜ. These are known as the “gates” such that if the sigmoid output is near 0, the gate signals have the effect of inhibiting the propagation of the corresponding input signal. Accordingly, the input gate iₜ is used to control the effect of the signal input. The forget gate fₜ is used to clear the memory. The output gate oₜ is used to clear the hidden output. The effect of the three gates iₜ, fₜ and oₜ on the running memory sₜ, and the hidden output hₜ can be observed in Eqns. (4) and (5). This gate combination in LSTM helps preserve the long term and short-term temporal relevance in time sequences of variable length.

While the LSTM is able to build contextual memory through time, this context at time step t is limited to at most from time step 0 to the current time step t and the generic LSTM do not make use of the future context (such t+1 to T) in processing xₜ. The bidirectional LSTM (BLSTM) can be utilized so as to alleviate this problem, shown here as RNN^{d1} 310a and RNN^{d2} 310b, in particular by utilizing the past and future context when the entire time sequence is available. The BLSTM is an extension to the generic LSTM where two different LSTMs process the time series from forward (LSTM^{d1}) and backward (LSTM^{d2}) directions respectively. The BLSTM can then be implemented so as to combine the outputs from each using an additional layer to obtain the final output 400.

With further reference to FIG. 1, in the proposed DCRNN architecture, each cell in the cellular sub-architecture 100 can be configured so as to hold a configurable LSTM network. Final outputs of each cell can then be aggregated and passed through a feed-forward network followed by classification 300. The proposed DCRNN architecture is shown provided a cellular front end of the proposed architecture which is expanded so as to overlap a multi-source 2D input pattern as shown in t=2, t=1, and t=0. This enables the LSTM network core in each cell to process the time series data generated from the corresponding sensor signal simultaneously. The LSTM core network within each cell can be configured as needed for a particular task. However, it has been recognized that certain advantages are realized when the system is configured so as to constrain the LSTM core architecture to be identical for each cell to ensure maximum trainable weight sharing. This novel DCRNN model, therefore, offers versatility of cellular neural processing combined with flexible time series processing of recurrent LSTM while keeping the spatial location information of input sensor signal.

It is also evident from FIG. 1 that communication paths exist between a given cell and its one or more neighboring cells, i.e. unique communication pathways 214 for corner cells, three for edge cells, and four for central cells. The neighborhood information processing occurs at each time step. For instance, consider the cell j, k of the cellular grid of size J×K is processing a time series at time step tt. Along with the input of time series at t, we configure an additional path to the core architecture coming from the neighbors ((j−1, k), (j+1, k), (j, K−1), (j, k+1)) outputs obtained at time t−1. In order to accommodate this additional neighbor information path in a 2D cellular setting, the system can then augment the LSTM equations taking the core at cell j, k as follows:

$$\begin{matrix}{i}_{j , k , t} = σ ( {W}_{i} {x}_{j , k , t} + {W}_{N i} {N}_{j , k , t} + {U}_{i} {h}_{t - 1} ) , & ( 6 ) \\ {f}_{j , k , t} = σ ( {W}_{j} {x}_{j , k , t} + {W}_{Nf} {N}_{j , k , t} + {U}_{f} {h}_{t - 1} ) , & ( 7 ) \\ {O}_{j , k , t} = σ ( {W}_{o} {x}_{j , k , t} + {W}_{No} {N}_{j , k , t} + {U}_{o} {h}_{t - 1} ) , & ( 8 ) \\ {S}_{j , k , t} = {f}_{j , k , t} ⊙ {S}_{j , k , t - 1} ⊙ {i}_{j , k , t} tan h ( {W}_{s} {x}_{j , k , t} + {W}_{N s} {N}_{j , k , t} + {U}_{s} {h}_{t - 1} ) , & ( 9 ) \\ {h}_{j , k , t} = {O}_{j , k , t} ⊙ tan h ( {S}_{j , k , t} ) . & ( 10 )\end{matrix}$$

Wherein equations 6-10 can be utilized to arrive at:

N_{j,k,t}=[h_{j+1,k,t+1},h_{j+1,k,t-1},h_{j,k-1,t-1},h_{j,k+1,t-1}]. (11)

It has then been recognized that the previous time-step hidden output information of the four closest neighbors given in eq. (11) are used as an additional input signal N_{j,k,t} for the LSTM network at each cell. With a G×1 dimensional hidden output per cell. In this implementation the system can be utilized so as to assign just one neuron output (the G^{th} element) as the output for neighbors. Though this is configurable to be different for each neighboring cell, it has been discovered that a single neighbor output per cell is sufficient for adequate performance.

The cellular configuration then makes it necessary to hold cell specific intermediate, final hidden, and memory outputs as shown in Eqns. (6) to (10). However, maintaining identical LSTM settings for each cell allows sharing of trainable parameters. Though only shown for a single LSTM layer, the cell core architecture can be expanded for multiple layers or bidirectional processing as necessary. The final outputs at time step T of each cell h_{j,k,T} are aggregated to obtain the feature vector H. Subsequently, the feature vector H can then be subsequently passed through the feed-forward sub-net so as to obtain the final output as follows:

FF=σ(W_{ff}H+b_{ff}), (12)=

y̅=softmax(W_{y̅}FF+b_{y̅}), (13)

Given the ground truth classification as y, the classification error E is computed using the Mean Squared Error based loss-function:

E=½∥y−y̅∥₂²; (14)

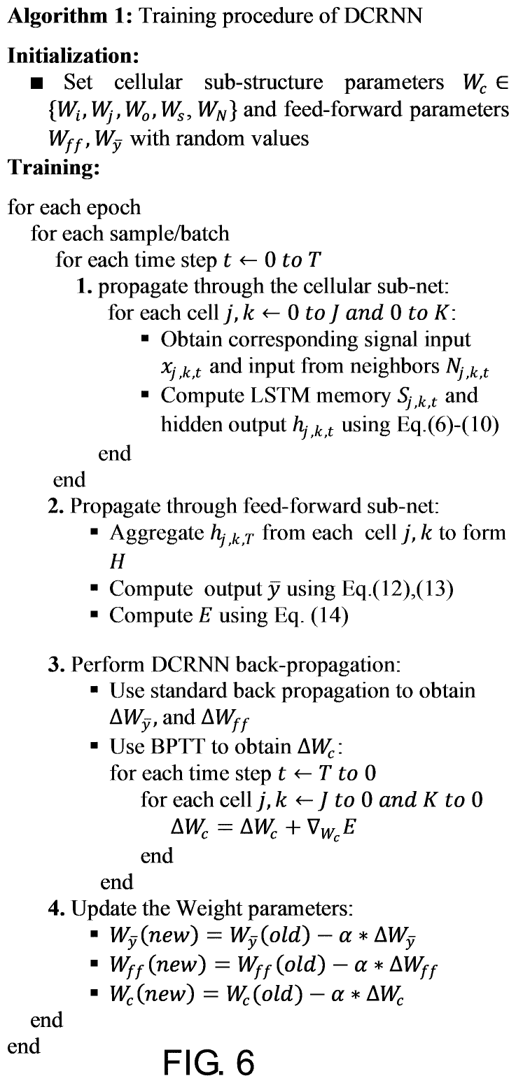

The training of the network is performed by obtaining partial derivatives of feed-forward weights ΔW_{y̅} and ΔW_{ff} using standard back-propagation algorithm, and ΔW_{c} using back-propagation through time across all cells. The detailed training procedure of the proposed DCRNN architecture is shown in Algorithm 1 as illustrated in FIG. 6

One clear advantage for DCRNN is the extensive use of weight sharing in the cellular recurrent sub-architecture as shown in FIG. 3. This is evident especially when the DCRNN is used to process time series data with multiple sensor signal sources spread in 2D space. Consider a time series data sample at time-step t with J×K individual signal sources spread in a 2D space. The total number of parameters (N_{DCRNN}) of the DCRNN architecture is given by the equation:

$${N}_{DCRNN} = {( {n}_{C L S T M} \times m )}_{( LSTM weights in a cell )} + {( J \times K \times {n}_{f f} )}_{( feed - forward weights )} + {c \times {n}_{f f}}_{( classifier )} \qquad ( 15 )$$

Whereas, the required number of parameters (N_{DLSTM}) of a deep LSTM with similar depth is given the equation:

N_{DLSTM}=(n_{LSTM}×m×J×K)+(n_{LSTM}×n_{ff})+c×n_{ff} (16)

Considering the LSTM network contains multiple trainable weights as shown in Eq. (1) to (5), the upper bound of the required number of parameters for the generic deep LSTM (DLSTM) in presence of above data is O(n_{LSTM}×m×J×K) where m denotes the dimensionality of the data in a single signal source. Conversely, the cellular architecture with weight sharing manages to process the same data with just O(n_{CLSTM}×m) complexity. Further, as illustrated here, typically n_{LSTM}>>n_{CLSTM} due to the large sensor signal input dimensionality faced by the generic DLSTM architecture. In contrast, the DCRNN requires very small amount of recurrent LSTM core units within each cell as the cellular architecture processes data from each sensor signal source separately.

As discussed briefly above, FIG. 2 illustrates, an implementation of the system onto a multi-channel scalp EEG, wherein data exhibits the characteristic of time-series with spatial locality. One exemplary spatial locality of this particular implementation is embodied specifically by an interest in automated EEG signal processing as EEG signal collected at different locations in a person's brain, wherein activity with particular wavelength readings can represent specific seizure activity. Accordingly, the system can then utilize a multi-channel scalp EEG dataset known as the CHB-MIT EEG database. This dataset consists of long-term multi-channel EEG recorded from multiple pediatric patients with intractable seizures. More importantly, the scalp EEG setup used in most cases contain 23 bipolar EEG signals recorded from individual electrodes placed according to the International Federation of Clinical Neurophysiology 10-20 system.

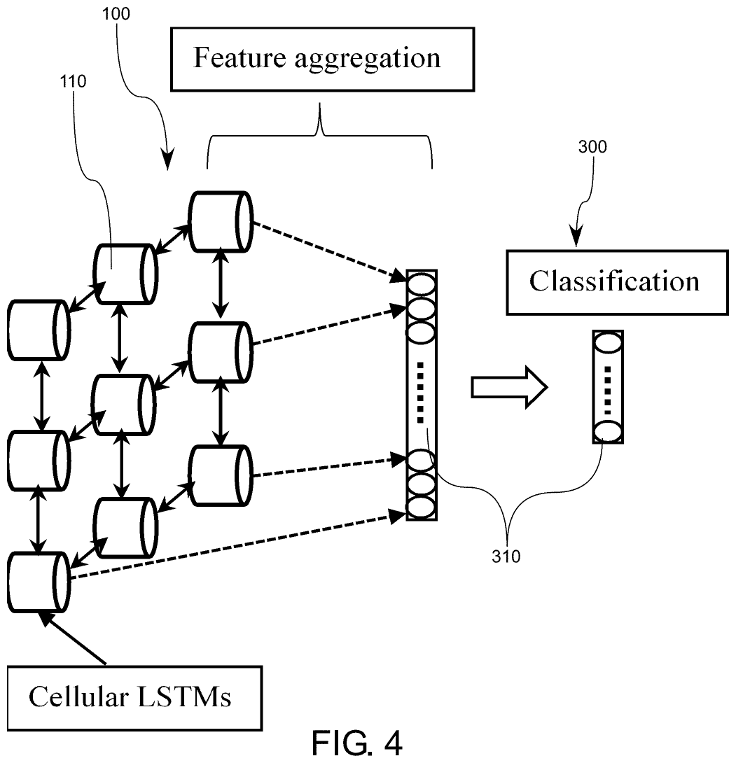

For effective processing of the EEG with spatial orientations intact, the system is configured so as to map the EEG montage with 18 representative bipolar channels into a 2D grid setting for better visualization as shown in FIG. 2. Note that the raw EEG signals localized as shown in FIG. 2 matches with a 2D spatial input arrangement required for the proposed DCRNN architecture in an input grid arrangement of size J=4 and K=5. Note the mapping in FIG. 4 is scalable that any additional signal sources (channels) may be easily accommodated by rearranging the specified grid. This simply expands the cellular arrangement of the DCRNN correspondingly without additional complexity due to weight sharing. The system was then configured to utilize this dataset arrangement with the proposed DCRNN architecture to perform automated seizure detection.

In this implementation, the DCRNN architecture can be configured for analysis with EEG dataset as follows. The system can be arranged to first implement the cellular recurrent architecture based on the EEG input mapping shown in FIG. 2. In the cellular sub-net, the system can implement a bidirectional LSTM architecture with 5 LSTM units in each direction. Note that the bidirectional LSTM architecture is made identical in all cells to allow sharing of trainable weights. The outputs from bidirectional architecture is aggregated across all cells and passed to the first feed-forward layer consisting of 50 neurons. The final classification layer configured for two class classification (seizure vs. non-seizure EEG) with softmax activation. The other feed-forward layers utilize sigmoid activation as discussed in Eq. (12). With this setup, each 1 second segment of EEG is classified as either normal or seizure EEG.

With regard to the scalp EEG dataset in conjunction with the scenario of FIG. 2. In this scenario, the scalp EEG dataset including a plurality of long-term bipolar referenced multi-channel EEG waveforms recorded from pediatric patients with epileptic seizures. When applied, the system was configured to utilize EEG data from 20 patients containing 124 separate seizure events for the analysis. The EEG waveforms were recorded in continuous segments of 1 to 4-hour duration. All EEG time series signals were sampled at 256 Hz. The Seizure events within the long-term EEG segments are annotated by an expert [33]. The system was then configured to perform patient specific seizure detection using the proposed DCRNN model.

The EEG preparation for analysis is as follows. The system was then configured to extract and segment all available raw seizure EEG into 1 second segments. The system subsequently segmented the non-seizure EEG into 1 second segment and perform randomized under sampling to obtain a patient specific dataset of seizure and non-seizure EEG. It should be understood that for this implementation the system was configured to simply normalize the raw EEG without any additional pre-processing or feature extraction for this analysis. The patient specific dataset is can then be utilized in a 5-fold cross validation procedure to observe the performance of the proposed architecture.

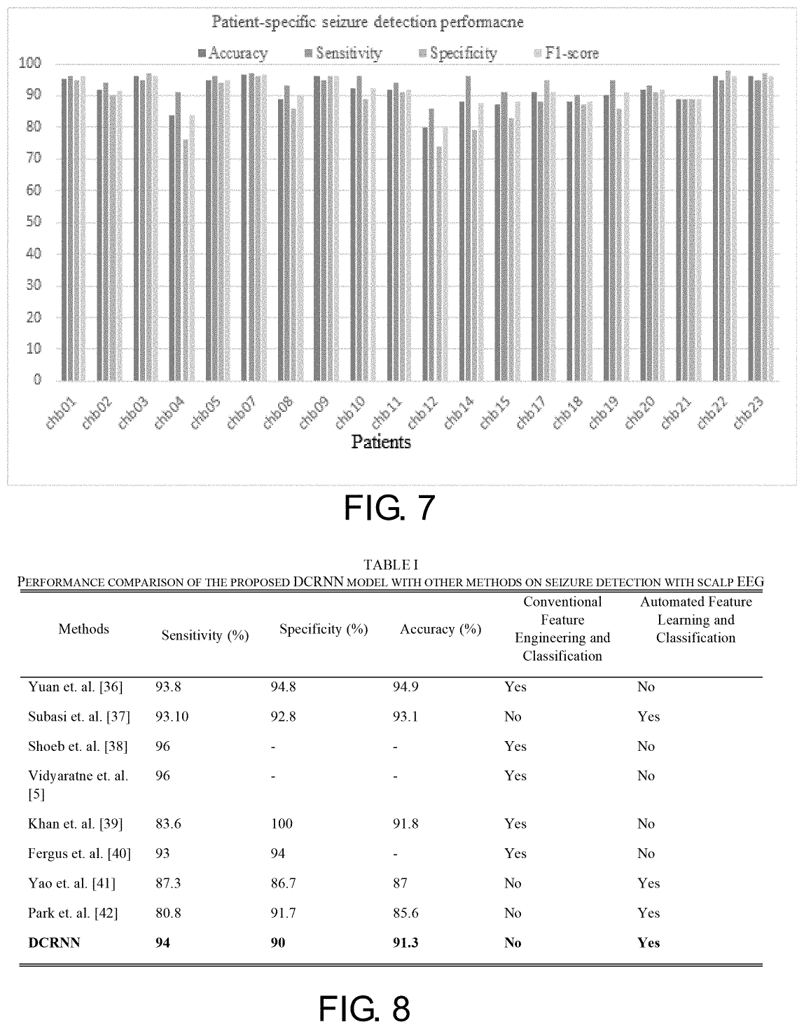

FIG. 7 illustrates a graphical representation which summarizes the patient specific EEG classification results obtained with the DCRNN architecture. According to FIG. 7, seizure detection accuracy for most patients are well over 90%. Specifically, the DCRNN achieves an average accuracy of 91.3% with a median of 92.1%. However, when seizure detection criterion is considered, sensitivity score plays a more important role. This is due to the fact that in a realistic setting, one would expect to correctly identify all seizure events even at the cost of a relatively higher false positive numbers. Consequently, the proposed architecture achieves an average sensitivity value of 94% with a median sensitivity of 95%. The DCRNN model still manages to maintain a median specificity value of 90.5%. The proposed model also achieves a mean and median F1 scores of 91.4% and 92.25% respectively.

The table as contained in FIG. 8 then compares the seizure detection performance of the proposed DCRNN model with other studies in the prior art. This table then shows that the proposed architecture manages to achieve comparable seizure detection performance to other state-of-the-art methods in literature.

In contrast to pre-existing systems, the proposed DCRNN contains only 5 bidirectional LSTM units in the recurrent hidden layers of each cell. With cellular weight sharing, the proposed system and methods can maintain a common number of units among all cells that process corresponding channels. This comparison shows the highly superior computational efficiency of the proposed architecture. In summary, the proposed architecture performs efficient feature learning and classification simply utilizing minimally pre-processed EEG. Moreover, time series processing with LSTM is performed within the cellular sub-net, which allows for simultaneous processing of each EEG channel while taking into account the locality of electrodes on the scalp. Minimal pre-processing with automatic feature learning and efficient use of trainable weights make DCRNN desirable for multi-channel EEG processing applications.

In order to investigate the versatility of the proposed DCRNN architecture across multiple applications, and as discussed briefly above, FIG. 3 illustrates, an implementation of the system onto the system can also be configured to analyze a second dataset for machine fault detection. The dataset is derived from a database maintained by the Jefferson National Laboratory based on the hardware specific faults encountered in the particle accelerator facility. A brief description of the hardware arrangement is as follows. The Continuous Electron Beam Accelerator Facility (CEBAF) at Jefferson Laboratory incorporates multiple cryomodules with superconducting radio frequency (SRF) cavities. Each cryomodule contains eight such cavities connected serially. A fault that occurs in any of these cavities disrupt the experimentation at the CBAF facility. In summary, multiple radio frequency (RF) signals are recorded from each SRF cavity in each cryomodule and a database of recording with cavity faults are maintained for further study.

The system can then be implemented so as to utilize this database for automated multi-class fault detection with the proposed DCRNN. The cavities are arranged in a serial fashion within the cryomodule. For purposes of illustration five representative RF time-series signals per cavity based on expert recommendation were selected. The system then was utilized so as to subsequently map the eight cavities and corresponding RF signals in a 2D grid layout as shown in FIG. 3. With this mapping, the 5 time series data from each cavity is separated in rows while the serial cavity arrangement is preserved in columns. This ultimately obtains a grid of size J=5 and K=8, and an efficient 2D arrangement for the proposed DCRNN architecture.

While the DCRNN architecture is configured for the machine fault detection data analysis as follows. The system is configured to implement the cellular recurrent architecture to complement the data mapping arrangement in FIG. 3. Accordingly, the cellular sub-architecture contains 40 individual cells in 5×8 configuration. Within each cell, the system can be configured to setup a unidirectional LSTM architecture consisting of 5 LSTM units. Similar to EEG, the LSTM sub-sub-architecture is made identical in each cell to ensure full weight sharing. Final outputs of LSTMs in each cell is aggregated and processed through a feed-forward layer consisting 100 neurons following Eq. (12). The final classification layer is configured for a 5-class classification task with softmax activation. The system can then classify each of the ˜600 waveform events based on the corresponding fault class.

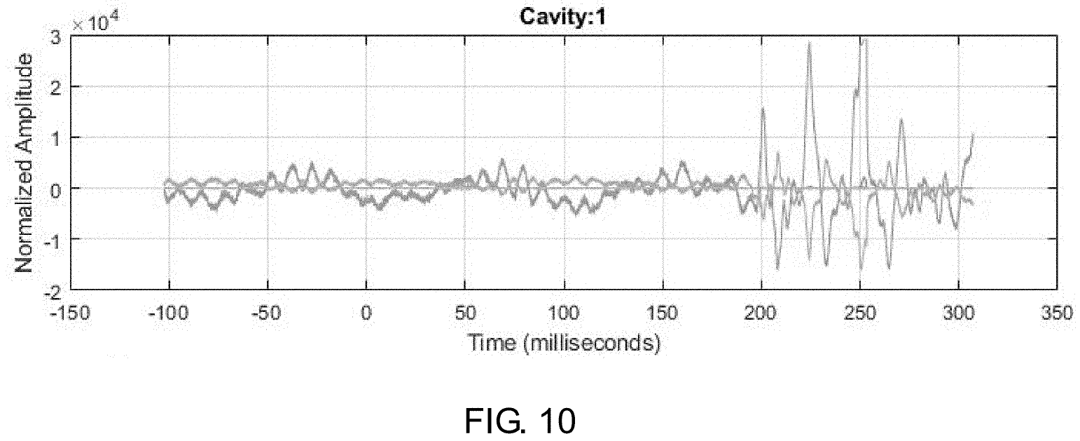

With regard to the machine fault detection dataset as depicted in the scenario of FIG. 3, the Jefferson Labs machine fault detection dataset includes approximately 600 samples of cavity waveform data acquired from the particle accelerator system. Each sample contains 17 RF waveforms recorded from each of the 8 SRF cavities. Each waveform contains ˜1.6 seconds (8196 individual time samples) of data that includes system failure due to a certain fault event. The dataset is inspected and categorized into 5 known fault types by an expert. An example waveform extracted from cavity 1 is shown in FIG. 10.

In this application the system was provided with five of the most significant RF waveforms for analysis based on visual analysis by an expert. The system was then configured to subsequently normalize the waveforms based on the z-score normalization technique. Even though the RF waveforms are sampled at a very high rate, it will be observed that the actual fault event is a relatively low frequency event. Therefore, in application the system and methods were configured to perform aggressive down sampling of the selected waveforms by a factor of 20 to obtain time series data of approx. 410 time samples. The data was subsequently arranged based on the mapping visualized in FIG. 3. The dataset was then utilized in a 10-fold cross validation process to obtain the performance of the proposed DCRNN architecture.

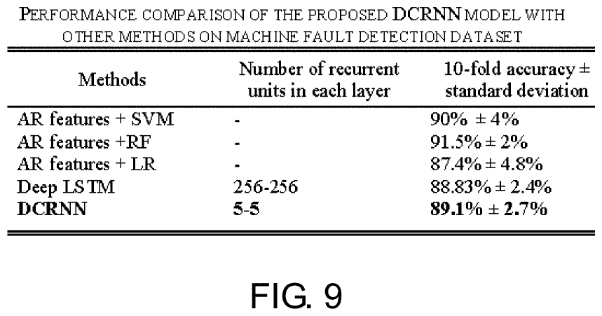

In order to compare the performance of DCRNN on the fault classification dataset, the system was compared with a pre-existing bidirectional LSTM architecture with two 256 LSTM units each followed by a feed forward layer of 512 neurons and a 5-class classification layer. For this, the pre-existing system then performed feature extraction on 5 selected waveforms utilizing autoregressive (AR) analysis. Accordingly, the pre-existing system obtained a 6-dimensional feature vector per waveform so as to construct a 240 (6 features×5 waveforms×8 cavities) element feature vector for each data sample. The pre-existing system then subsequently performed 10-fold cross validation analysis using classifiers such as Logistic regression (LR), support vector machine (SVM), and Random Forrest (RF). The 10-fold cross validation performance of the proposed architecture performance of the proposed along with comparison with other methods are shown in the table provided in FIG. 9.

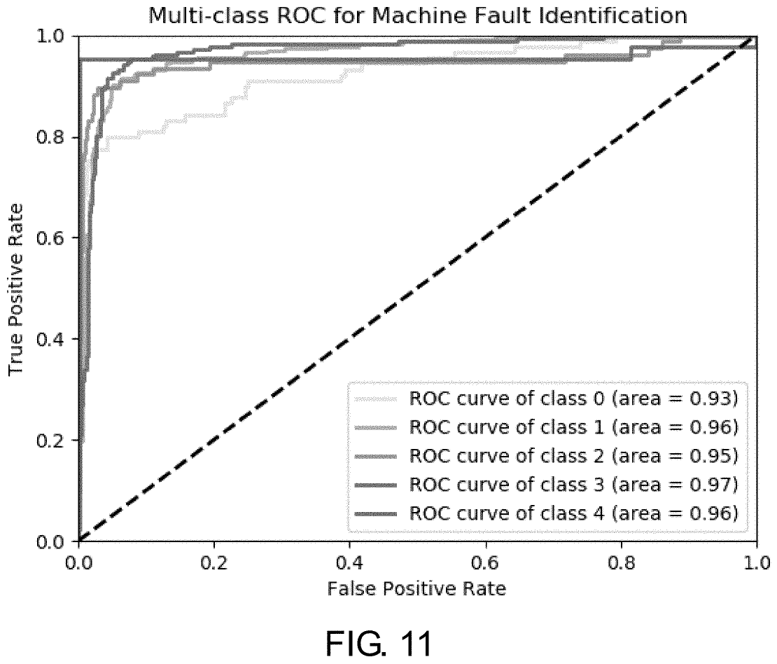

As shown in this table, between the two deep learning models, the proposed DCRNN offers comparable accuracy. However, note the large difference in hidden LSTM units used for the recurrent layers in both deep LSTM and DCRNN. This is due to the cellular processing feature that maintains the location information for sensor signal in DCRNN as illustrated in FIG. 1. Therefore, with regard to the proposed system, the input dimensionality of the sensor signal per cell is comparably quite small, and will require much smaller number of LSTM units per cell. Moreover, since the LSTM architecture is shared among cells, the number of trainable parameters does not grow in size. The ROC curve of the proposed DCRNN for multi-class processing of the contemplated architecture is shown in FIG. 11. The area under the curve is consistently near unity for all 5 classes indicating that the proposed algorithm utilized on the proposed system provides high sensitivity and specificity, without a need to sacrifice either.

Though the machine learning based methods of the proposed invention, as shown in the table of FIG. 9, perform slightly better than that of the proposed DCRNN model, it should be appreciated that the associated pipeline requires autoregressive feature extraction from each RF waveform of each cavity. This may be a tedious and computationally intensive process, especially if the number of waveforms or the cavities are higher. The proposed DCRNN architecture is quite helpful in this regard as it simply requires to expand the cellular grid to accommodate the increased input sources. Additionally, the trainable weight sharing property of the cellular architecture in the proposed model helps to minimize the computational complexity.

In accordance with the above disclosure, the proposed invention proposes a novel deep cellular recurrent neural network (DCRNN) architecture for efficient processing of large-scale time-series data with spatial relevance. The DCRNN model consists of a cellular recurrent sub-network that operates in 2D space to enable efficient processing of time series data while considering multiple signals from spatially distributed sensors. The cellular architecture processes data from each localized sensor signal source individually in a synchronized manner. This 2D distributed processing approach enables minimum use of recurrent LSTM units within each cell due to the locally reduced input dimensionality. Moreover, time series data obtained from spatially distributed sensor systems such as multi-channel EEG may hold importance in the locality of the sensor signal for many associated tasks. The cellular architecture of the proposed DCRNN preserves the locality of the distributed sensor signals by mapping itself onto the 2D space. The inter-cellular weight sharing property further improves the efficiency of the proposed model. The performance of the proposed DCRNN model is evaluated using two large-scale time series datasets obtained from biomedical and machine fault analysis domains. The results show that the proposed architecture achieves state-of-the-art performance with respect to comparable machine learning and deep learning methods while utilizing significantly less amount of recurrent processing units and trainable parameters.

Also contemplated herein is a method of implementing a machine learning system as described above which can include the following steps: providing a plurality of sensors being located on a computational front-end; providing a deep cellular recurrent neural network configured to receive time-series data input from each of the plurality of sensor, the deep cellular recurrent neural network including a plurality cellular long short-term memory networks arranged in corresponding nodes, wherein each of the plurality of cellular long short-term memory networks are interconnected to at least one adjacent cellular long short-term memory module; and providing one or more feed-forward layers being located on a computational back-end configured to receive data output, the data output being processed by the deep cellular recurrent neural network.

The method of implementing a machine learning system can also include the step of: arranging the plurality of sensors into a nodular array, wherein the plurality of sensors are then configured to provide the time-series data input in a nodular array corresponding in parameters to the nodular array in which the plurality of sensors are arranged.

The method of implementing a machine learning system can also include the step of: arranging the plurality cellular long short-term memory networks into a nodular array corresponding in shape to the nodular array in which the time-series data input is arranged, wherein the nodular array of the time-series data input is provided in the form of a matrix having a plurality of columns and rows each cell in the matrix being representative of the time-series data input being provided by each of the plurality of sensors, wherein the matrix representative of the nodular array of the time-series data input is symmetrical about two perpendicular axes of the matrix.

The method of implementing a machine learning system can also include the step of: providing one or more unique communication channels between each adjacent nodes of the plurality cellular long short-term memory networks.

The method of implementing a machine learning system can also include the steps of: sharing computational load between adjacent long short-term memory network nodes through the unique communication channel; and utilizing a plurality of adjacent long short-term memory network nodes to analyze data from a common cell of the matrix representing the nodular array of the time-series data input.

It is noted that no specific order is required in the aforementioned methods, though generally these method steps can be carried out sequentially.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

We claim:

1. A machine learning system comprising:
a plurality of sensors being located on a computational front-end;
a deep cellular recurrent neural network configured to receive time-series data input from each of the plurality of sensor, the deep cellular recurrent neural network comprising:
a plurality cellular long short-term memory networks arranged in corresponding nodes, wherein each of the plurality of cellular long short-term memory networks are interconnected to at least one adjacent cellular long short-term memory module; and
one or more feed-forward layers being located on a computational back-end configured to receive data output, the data output being processed by the deep cellular recurrent neural network.

2. The machine learning system of claim 1, wherein the plurality of sensors are arranged in a nodular array, wherein the plurality of sensors are then configured to provide the time-series data input in a nodular array corresponding in parameters to the nodular array in which the plurality of sensors are arranged.

3. The machine learning system of claim 2, wherein the plurality cellular long short-term memory networks are arranged in a nodular array corresponding in shape to the nodular array in which the time-series data input is arranged.

4. The machine learning system of claim 3, wherein the nodular array of the time-series data input is provided in the form of a matrix having a plurality of columns and rows each cell in the matrix being representative of the time-series data input being provided by each of the plurality of sensors.

5. The machine learning system of claim 4, wherein the matrix representative of the nodular array of the time-series data input is symmetrical about one or more axes of the matrix.

6. The machine learning system of claim 4, wherein the matrix representative of the nodular array of the time-series data input is symmetrical about both horizontal and vertical axes of the matrix.

7. The machine learning system of claim 3, wherein each of the plurality cellular long short-term memory networks are provided with one or more unique communication channels between one or more adjacent cellular long short-term memory networks.

8. The machine learning system of claim 7, wherein each of the plurality cellular long short-term memory networks are provided with one or more unique communication channels between one or more adjacent cellular long short-term memory networks.

9. The machine learning system of claim 5, wherein each of the plurality cellular long short-term memory networks are provided with one or more unique communication channels between one or more adjacent cellular long short-term memory networks.

10. The machine learning system of claim 9, wherein each of the plurality cellular long short-term memory networks are provided with one or more unique communication channels between one or more adjacent cellular long short-term memory networks.

11. The machine learning system of either claim 8 or REF_Ref36139880 \r \h \* MERGEFORMAT 10, wherein each of the plurality cellular long short-term memory networks are configured to share computational load between adjacent long short-term memory network nodes through the unique communication channel.

12. The machine learning system of claim 11, wherein a plurality of adjacent long short-term memory network nodes are configured to receive and to analyze data from a common cell of the matrix representing the nodular array of the time-series data input.

13. A method of implementing a machine learning system comprising:
providing a plurality of sensors being located on a computational front-end;
providing a deep cellular recurrent neural network configured to receive time-series data input from each of the plurality of sensor, the deep cellular recurrent neural network comprising:
a plurality cellular long short-term memory networks arranged in corresponding nodes, wherein each of the plurality of cellular long short-term memory networks are interconnected to at least one adjacent cellular long short-term memory module; and
providing one or more feed-forward layers being located on a computational back-end configured to receive data output, the data output being processed by the deep cellular recurrent neural network.

14. The method of implementing a machine learning system of claim 13, further comprising:
arranging the plurality of sensors into a nodular array, wherein the plurality of sensors are then configured to provide the time-series data input in a nodular array corresponding in parameters to the nodular array in which the plurality of sensors are arranged.

15. The method of implementing a machine learning system of claim 14, further comprising:
arranging the plurality cellular long short-term memory networks into a nodular array corresponding in shape to the nodular array in which the time-series data input is arranged, wherein the nodular array of the time-series data input is provided in the form of a matrix having a plurality of columns and rows each cell in the matrix being representative of the time-series data input being provided by each of the plurality of sensors, wherein the matrix representative of the nodular array of the time-series data input is symmetrical about two perpendicular axes of the matrix.

16. The method of implementing a machine learning system of claim 15, further comprising:
providing one or more unique communication channels between each adjacent nodes of the plurality cellular long short-term memory networks.

17. The method of implementing a machine learning system of claim 16, further comprising:
sharing computational load between adjacent long short-term memory network nodes through the unique communication channel; and
utilizing a plurality of adjacent long short-term memory network nodes to analyze data from a common cell of the matrix representing the nodular array of the time-series data input.

18. A machine learning system comprising:
a plurality of sensors being located on a computational front-end;
a deep cellular recurrent neural network configured to receive time-series data input from each of the plurality of sensor, the deep cellular recurrent neural network comprising:
a plurality cellular long short-term memory networks arranged in corresponding nodes, wherein each of the plurality of cellular long short-term memory networks are interconnected to at least one adjacent cellular long short-term memory module; and
one or more feed-forward layers being located on a computational back-end configured to receive data output, the data output being processed by the deep cellular recurrent neural network;
wherein the plurality of sensors are arranged in a nodular array, wherein the plurality of sensors are then configured to provide the time-series data input in a nodular array corresponding in parameters to the nodular array in which the plurality of sensors are arranged;
wherein the plurality cellular long short-term memory networks are arranged in a nodular array corresponding in shape to the nodular array in which the time-series data input is arranged;
wherein the nodular array of the time-series data input is provided in the form of a matrix having a plurality of columns and rows each cell in the matrix being representative of the time-series data input being provided by each of the plurality of sensors;
wherein the matrix representative of the nodular array of the time-series data input is symmetrical about both horizontal and vertical axes of the matrix;
wherein each of the plurality cellular long short-term memory networks are provided with one or more unique communication channels between one or more adjacent cellular long short-term memory networks;
wherein each of the plurality cellular long short-term memory networks are configured to share computational load between adjacent long short-term memory network nodes through the unique communication channel; and
wherein a plurality of adjacent long short-term memory network nodes are configured to receive and to analyze data from a common cell of the matrix representing the nodular array of the time-series data input.
